(19) United States
(12) Patent Application Publication
(10) Pub. No.: US 2008/0093303 A1
(43) Pub. Date: Apr. 24, 2008

(54) Method for removal of nano-sized pathogens from liquids

(76) Inventors: Mario Elmen Tremblay, West Chester, OH (US); Steve Gary Fishter, Harrison, OH (US); Dimitris Ioannis Collias, Mason, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/349,866

(22) Filed: Feb. 8, 2006

Related U.S. Application Data
(62) Division of application No. 09/574,456, filed on May 19, 2000, now abandoned.
(60) Provisional application No. 60/135,083, filed on May 20, 1999.

(51) Int. Cl. B01D 15/04

(52) U.S. Cl. 210/690; 210/767

(57) ABSTRACT

A method of removing nano-sized pathogens from a liquid that includes providing a filter and contacting the filter with a liquid to remove nano-sized pathogens from the liquid. The filter includes a housing and a filter core disposed within the housing. The filter core comprises activated carbon particles, excluding sodium hydroxide treated activated carbon particles, wherein the activated carbon particles have an interparticle spacing wherein the filter has a Pathogen Removal Index (PRI) of at least about 99.99%.

### CROSS REFERENCE TO RELATED APPLICATION

This application is a divisional of U.S. application Ser. No. 09/574,456, filed on May 19, 2000, which claims the benefit of U.S. Provisional Application No. 60/135,083, filed May 20, 1999.

### TECHNICAL FIELD

The present invention relates to the use of filters capable of removing nano-sized pathogens, including viruses, from liquids by filtration. In particular, it relates to the use of filters that comprise activated carbon particles for removing viruses from liquids.

### BACKGROUND OF THE INVENTION

Water may contain many different kinds of nano-sized pathogens such as viruses. In a variety of circumstances, these viruses must be removed before the water can be used. However, despite modern water purification means, the general population is at risk, and in particular infants and persons with compromised immune systems are at considerable risk. Breakdown and other problems with water treatment systems sometimes lead to incomplete removal of potential pathogens. There are deadly consequences associated with exposure to contaminated water, as some countries have increasing population densities, increasingly scarce water resources, and no water treatment utilities. It is common for sources of drinking water to be in close proximity to human and animal waste, such that microbiological contamination is a major health concern. As a result of waterborne microbiological contamination, an estimated six million people die each year, half of which are children under 5 years of age.

In the U.S., the National Sanitation Foundation (NSF), based on Environmental Protection Agency (EPA) studies, introduced standards that must be met for drinking water. The purpose of these standards is to establish minimum requirements regarding the performance of drinking water treatment systems that are designed to reduce specific health related contaminants in public or private water supplies. Established in 1991, Standard 55 requires that the effluent from a water supply source exhibit 99.99% removal of viruses against a challenge. As a representative microorganism for nano-sized pathogens, MS-2 bacteriophage is typically used because its size and shape (i.e., 25 nm and spherical) make it a particularly difficult microorganism to be removed from liquids, relative to nano-sized pathogens such as viruses. Thus, a filter's ability to remove MS-2 bacteriophage demonstrates its ability to remove nano-sized pathogens, such as viruses.

Therefore there is a need for a filter capable of removing a broad spectrum of nano-sized pathogens such as viruses. This filter would comprise a single, small, lightweight, self-contained system rather than a complex multi-component and/or multistage system to remove the various viruses. Such a filter would not only be more reliable than a complex system, but it would also be far more portable and economical. Thus, it could be utilized as a simple device on faucets in domestic settings where well water or water from a municipal source is used. In another application, such a device could be utilized in lesser developed regions of the world on a faucet or container for storing drinking water, where communal water sources are shared, but little is done to treat the water for contamination. A small, inexpensive, easy-to-use, water filter would be of great humanitarian value. In certain applications, the filter should present a low resistance to the flow of water so that in locations where electricity necessary to drive a pump may be unavailable, the filter may simply be connected between upper and lower containers of water, or between the holding container and a drinking receptacle. In certain embodiments, the filter should also have sufficient structural integrity to withstand significant pressures if, for example, a source of pressure is available to drive the liquid through the filtering apparatus (e.g. mechanical pump, faucet pumped water, etc.).

Despite centuries of a well-recognized need and many development efforts, activated carbon in its various forms has never been shown to reliably remove nano-sized pathogens from water or enjoyed wide-spread commercial use for nano-sized pathogen removal per se. Many attempts have been made over the years to apply activated carbon to pathogen removal without notable success. In the United States, the patent literature reflects that improved activated carbon particles and water treatment structures have been sought for water purification since at least the 1800's. For example, U.S. Pat. No. 29,560 (Belton, issued Aug. 14, 1860) teaches that an adsorptive carbon can be made by combining peat, cut out of the bog, with chalk in water to make a paste, followed by molding and firing. U.S. Pat. No. 286,370 (Baker, issued Oct. 9, 1883) teaches that artificial bone black blocks made from a slurry of finely powdered charred bones and magnesia can be used to good effect in water filters. The U.S. EPA has taught against the use of activated carbon alone for nano-sized pathogen removal, stating that “activated carbon [even] with silver does not remove all viruses from water” (see 59 Federal Register 223, Nov. 21, 1994).

While prior art references have previously utilized activated carbon in water filters, it is evident that the activated carbon is being employed to remove organic and inorganic chemical matter. Thus, to the extent that certain prior art references disclose the use of activated carbon to treat a water source with respect to pathogen removal, including viruses, such approaches require the use of additional treatment steps or they require a relatively complex assembly of components.

In view of the foregoing, it has now been surprisingly discovered that a filter comprising activated carbon particles alone can reliably remove nano-sized pathogens from water. Accordingly, an object of the present invention is to provide a method for removing nano-sized pathogens from a water source. A specific object includes use of a water filter which removes nano-sized pathogens from the water source. The removal of such pathogens using such a filter is at a level not previously demonstrated by the prior art. Such a filter will preferably present a low resistance to the flow of liquid through it, and will remove the pathogens from a substantial volume of water before becoming saturated. In certain embodiments, the filter will also preferably be relatively portable.

### SUMMARY OF THE INVENTION

The invention relates to a method of removing nano-sized pathogens from a liquid, the method comprising contacting the liquid with a filter comprising activated carbon particles wherein said filter has a Pathogen Removal Index (“PRI”, determined according to the test method section below) of at least about 99.99%.

The invention further relates to an article of manufacture comprising:
(a) a filter comprising activated carbon particles, wherein said filter has an PRI of at least about 99.99%; and
(b) information which communicates to a user that the filter may be used to remove nano-sized pathogens from a liquid.

### BRIEF DESCRIPTION OF THE DRAWINGS

FIG. 1 is a representation of the flow paths of viruses between activated carbon particles.

FIG. 2 is a representation which illustrates the packing facilitated by use of activated carbon particles of differing size.

### DETAILED DESCRIPTION OF THE PRESENT INVENTION

### I. Definitions

As used herein, “Activated Carbon Particles” (ACP) mean activated carbon in any form such as granular, spherical, pelletted, irregular shapes or other particles coated with activated carbon.

As used herein, a “filter” is any article of manufacture containing the ACP to enable its function in removing nano-sized pathogens from liquid. Such a filter may be as simple as the ACP and an enclosure means to retain the ACP. It is apparent that such an enclosure must be capable of preventing loss of ACP during operation, as well as maintaining the desired inter-particle network during use.

As used herein, the terms “filters” and “filtration” refer primarily to removal via adsorption.

As used herein, the terms liquid and water are used interchangeably.

As used herein, the term “nano-sized pathogens” refers to pathogens ranging in size from about 20 nm to about 500 nm.

### II. Activated Carbon Particles

Activated carbon particles can be characterized by their size, porosity, and specific surface area. Size is meant to describe the longest dimension of the particle. Porosity is characterized by the mean pore size of the particles. Specific surface area is a measure of the particle surface area, including the area within the pores, per unit of mass of particle. For the present invention, ACP will preferably have: specific surface areas in a range of from about 100 to about 4000 m²/g, more preferably from about 500 to about 3000 m²/g, still more preferably about 1000 to about 2500 m²/g; sizes in a range of from about 0.1 to about 5000 μm, more preferably about 1 to about 1000 μm, still more preferably about 4 to about 275 μm; and pore sizes from about 2.5 Å to about 300 nm, more preferably from about 5 Å to about 200 nm, still more preferably from about 10 Å to about 100 nm.

### III. Filters

A. Structures

Bulk density is commonly used in the art to describe carbon-containing structures. The filters of the present invention will have a bulk density of from about 0.1 to about 1.2 g/cm³, preferably from about 0.4 to about 1.0 g/cm³, still more preferably about 0.6 to about 0.8 g/cm³. In having calculated the bulk density and knowing the dimensions of the activated carbon particles one can determine the average interstitial spacing between particles. Applicants have discovered that interstitial spacing between particles (also called inter-particle spacing or distance) is the critical parameter which controls the removal of nano-sized pathogens.

While not wishing to bound by theory, it is believed that the surprising ability of the present filters to remove nano-sized pathogens, particularly viruses, is due to inter-particle spacing that results from the packing of the activated carbon particles. It is believed that the attachment of nano-sized pathogens, and in particular viruses, onto activated carbon particles is governed by electrostatic, van der Waals, and hydrophobic forces. These forces have different signs, or equivalently, some of them are attractive and some repulsive. For example, the electrostatic forces are typically repulsive since most of the surfaces are negatively charged (except for modified surfaces as well as some unmodified clay structures and asbestos). On the other hand, van der Waals and hydrophobic forces are typically attractive. The net effect of all these forces is typically a minimum in the interaction energy, called secondary minimum, that causes nano-sized pathogens to attach to surfaces. In terms of interaction distances, electrostatic forces have a characteristic distance of about 50 nm, whereas van der Waals forces have a characteristic distance of about 100 nm. In addition to the above forces, some nano-sized pathogens, due to their structural characteristics, contain polymeric outer shells and in some cases appendages of various lengths. Furthermore, some nano-sized pathogens excrete various polymeric substances during their metabolic cycle that is believed to cause strengthening of the attachment as well as increase in the attachment sites for nano-sized pathogens that follow them.

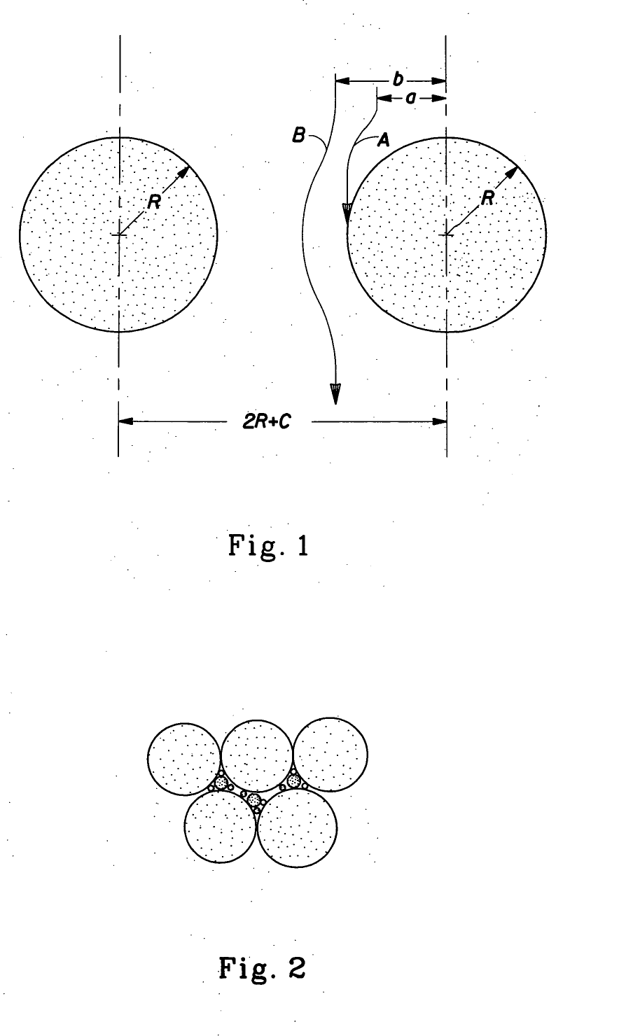

With reference to FIG. 1, in terms of the mechanics of the flow of pathogens in the filter, it is believed that the distance between two adjacent particles, c, is critical in achieving attachment of pathogens to the particles. In general, pathogens might flow close to the surface of a particle so that the overall attractive force would cause them to attach to the surface (see pathogen A in FIG. 1). On the other hand, pathogens might flow far away from the particle surface so that the overall attractive force cannot “pull” them towards the particle surface for attachment (see pathogen B in FIG. 1).

In terms of the effect of the inter-particle distance (also called spacing) on pathogen attachment onto the particle surface, it is believed that there is an optimum range of inter-particle distances that is necessary for pathogen attachment to particles and removal from water. When this inter-particle distance, c (see FIG. 1), is relatively large, then the majority of pathogens do not come sufficiently close to the particle surface for the forces mentioned above to cause attachment to the surface. As a result, the majority of pathogens do not get removed from the incoming water, and thus behave as pathogen B in FIG. 1. On the other hand, when this inter-particle distance is relatively small, the majority of pathogens come close to the surface of the particle and experiences the forces mentioned above. However, the shear conditions at these small gaps are high, and it is expected that the shear forces are high enough to overcome the attractive forces between pathogen and carbon surfaces. In these conditions there might be some pathogens that behave like pathogens A in FIG. 1 that do get attached to the particles. However, it is expected that due to high shear forces these pathogens might experience dislodging at some later point in time. As a result, the majority of pathogens do not get removed from the incoming water. Therefore, there is an optimum range of inter-particle spacing that strikes a balance between shear forces, attractive and repulsive forces. This balance ensures that pathogens get removed during their flow in the carbon particle filters. Note that it is believed that the above described mechanism is applicable when the carbon surfaces have been modified, either chemically or physically, by adsorption of various compounds.

One process for building an activated carbon particle filter capable of removing nano-sized pathogens from a liquid comprises activated carbon particles extruded into the form of a hollow tube. An example of such an extrusion process is described in U.S. Pat. No. 5,331,037 (Koslow, Jul. 19, 1994) and U.S. Pat. No. 5,189,092 (Koslow, Feb. 23, 1993). EP 792 676 A1 (Koslow, published Mar. 9, 1997) describes the properties of a filter made via such a process. The disclosure of each of these references is incorporated by reference. Importantly, EP 792 676 A1 does not teach or suggest that the disclosed extruded activated carbon filters are capable of removing nano-sized pathogens from water. In fact, the reference discloses that the filters are only capable of removing up to 99.9% of particulates having a size of at least 500 nm.

Further and optionally, the carbon particles may be selected from a range of sizes so that when placed together, the inter-particle spacing between the first, and larger, size particles will closely conform to the second, and smaller, size particles, and so that successively smaller size particles will closely conform with the remaining interstitial space between the various selected larger particles. By the selection of particle sizes and forms, the interstitial space can be substantially controlled and made uniform at a smaller scale than would be possible if a single particle size is used. Additionally, the activated carbon particles may be combined with other particles, optionally of different shapes, to control inter-particle spacing. Such particles may be carbonaceous or non-carbonaceous.

In one embodiment illustrated in FIG. 2, the activated carbon filter may be comprised of aligned larger particles compressed with a plurality of smaller particles so that the smaller particles fill in the interstitial space between the large particles, forming successively smaller and parallel interstitial spaces along the axis of the particles and continuous in the axial particles direction through the entire structure. In this embodiment it can be seen that the size of the interstitial spaces created is much smaller than that achieved with uniform sized particles. Thus, the inter-particle spacing can be controlled by the sizes or size distribution of the particles selected.

B. Pathogen Removal Properties

The method of the present invention relates to the removal from a water source of at least about 99.99% of nano-sized pathogens. That is, the method relates to the use of a filter that exhibits a Pathogen Removal Index (“PRI”) of at least about 99.99%. Preferably, the filter will have a PRI of at least about 99.999%, more preferably at least about 99.9999%. Preferably, the filters will have a PRI of from about 99.99% to about 99.9999%.

The method of the present invention also relates to the removal from a water source at least about 99.99% of viruses. That is, the method includes the use of a filter that exhibits a Virus Removal Index (“VRI”) of at least about 99.99%. Preferably, the filter will have a VRI of at least about 99.999%, more preferably at least about 99.9999%. Preferably, the filters will have a PRI of from about 99.99% to about 99.9999%.

The article of manufacture of the present invention comprises:
(a) a filter comprising activated carbon particles, wherein said filter has a PRI or a VRI of at least about 99.99% (preferably the PRI or VRI will be about 99.999%, more preferably at least about 99.9999%); and
(b) information which communicates to a user that the filter may be used to remove nano-sized pathogens, especially viruses, from a water source.

It is evident that the filters and methods described herein allow the treatment of water in excess of the standards set forth by the EPA in the U.S. In addition, applicants have found that the use of the filters described herein may be used for long periods of time without becoming exhausted in terms of the ability to continue to remove nano-sized pathogens from the source stream. The use of such filters therefore would improve the health risk situation in many countries, based on the fact that the population in general would have less exposure to the various nano-sized pathogens, particularly viruses. Perhaps more importantly, in those geographies where contamination of the source water is significantly worse than that observed in more developed countries, the benefits provided by the present invention are magnified. For example, the ability to remove nano-sized pathogens at such a high level for such a long period of usage (i.e., before they reach failure because of saturation with the various nano-sized pathogens) allows for the purification, in terms of making water potable without undue health risk, of highly contaminated water.

C. Other Filter Components

As indicated, the filter will also include a housing for containing the activated carbon particles. A pre-filter can be used to provide particulate filtration of suspended solids that exceed 1 μm in size. A biocidal agent, such as silver, can be used to prevent biofilm formation with the filter system.

In one embodiment, the filter will comprise a housing containing a generally cylindrical filter arrangement. The housing has a liquid inlet and a liquid outlet and defines a liquid flow path between the inlet and outlet. The ACP arrangement is disposed within the housing in the liquid flow path and comprises a cylindrically shaped porous structure for removing particulate contaminants, chemical contaminants and microbiological contaminants from the liquid. The filter also includes impervious end members mounted to the ends of the filter arrangement, one of the end members having a central aperture. These end members direct liquid flow through the filter.

D. Articles of Manufacture

The present invention in another aspect comprises an article of manufacture comprising the ACP-containing filter and information that will communicate to the consumer, by words and/or by pictures, that use of the filter will provide water filtration benefits which include removal of nano-sized pathogens, particularly viruses, and this information may include the claim of superiority over other filter products. In a highly desirable variation, the article of manufacture bears the information that communicates to the consumer that the use of the filter provides reduced levels of nano-sized pathogens, including viruses. Accordingly, the use of packages in association with information that will communicate to the consumer, by words and/or by pictures, that use of the filter will provide benefits such as improved reduction of water contaminants as discussed herein, is important. The information can include, e.g., advertising in all of the usual media, as well as statements and icons on the package, or the filter itself, to inform the consumer.

### IV. Test Methods For Measuring Pathogen and Virus Removal Indices

The following is a description of the methods for assessing a filter's ability to remove pathogens (i.e., its Pathogen Removal Index), including viruses (i.e., its Virus Removal Index), when exposed to a challenge consisting of water containing nano-sized pathogens.

A. Filtration Protocol

Test fluid in the form of dechlorinated water containing nano-sized microorganism is flowed through the filter at a rate of 100 ml per min for a period of 6 hours. The test fluid contains MS-2 bacteriophage (American Type Culture Collection (ATCC); Rockville, Md.; ATCC# 15597B). The target concentration in the test fluid influent, based on the dilution from a concentrated stock, is 5×10⁸ MS-2 bacteriophages/L.

B. Assay Conditions for Determining Pathogen and Virus Removal Indices

The assay used to calculate the influent and effluent concentration and thus the PRI and VRI is performed as follows. Bacteriophage MS-2 is serially diluted in Tris Buffered Saline (TBS; Trisma Inc., St. Louis, Mo.). The serial dilution is performed by taking 0.3 ml of influent or effluent and adding to 2.7 ml of TBS. The dilution is continued until a 10⁻⁴ dilution is produced. Then, the 3 ml dilution is added to 3 ml of molten (46° C.) top agar (tryptic soy broth) with 1% Bacto agar, (Difco, Becton/Dickinson, Inc, Spark, Md.) containing 0.1 ml of log-phase culture of E. coli host (ATCC# 15597). The suspension is vortexed and poured onto solid tryptic soy agar plates. The tryptic soy agar (Difco) is prepared by adding 40 g of the powder to 1 L of purified water in a 2 L Erlenmeyer flask set on a stir/hot plate. A 2 in.×½ in. stir bar is added to the Erlenmeyer flask and the stir/hot plate is turned up to a medium setting. The tryptic soy agar solution is mixed thoroughly on the stir/hot plate and heated to boiling for 1 minute. The solution is then autoclaved for 15 minutes at 121° C. Then 15 ml of the tryptic soy agar is poured into a 92 mm×16 mm sterile Petri dish then cooled to produce the solid tryptic soy agar plate. The solid tryptic soy agar plates along with the top agar solution that has been added is incubated for 18-24 hours at 37° C. and then enumerated by counting plaques formed on the lawn of host E. coli cells.

The Virus Removal Index is calculated as a percentage using the following equation:

VRI=[1−(Virus Effluent Conc./Virus Influent Conc.)]×100

The PRI is calculated by substituting the specific pathogen concentration for the virus concentration.

### V. EXAMPLE

A filter core (KX Industries #20-185-125-083, KX Industries, L.P., Orange, Conn.) is inserted into a filter housing (USWP#1A). The filter housing is connected to an EXPERT Peristaltic pump (model CP-120; by Scilog, Inc., Madison, Wis.) using Pharmed tubing (¼ in. ID with 1/16 in. wall thickness).

One hundred liters of water to be used as influent is dechlorinated and sterilized and stored in a 30 gallon carboy set on top of a stirring plate. The MS-2 bacteriophage (ATCC# 15597B) is seeded into the influent as the influent is mixed with a 2 in. by ½ in. stir bar stirred by the stirring plate set on maximum speed. The target concentration in the influent, based on the dilution from a concentrated stock, is 5×10⁸ MS-2 bacteriophages per liter. A 50 ml sample of influent is collected into a 50 ml graduated conical centrifuge tube for assay of MS-2. Once the seeded influent water is passed through the test unit for 1 hour at the prescribed flow rate (i.e., 100 mL/min), 50 ml of effluent is collected into a 50 ml graduated conical centrifuge tube for assay of MS-2 bacteriophage. One ml of influent and effluent is needed to perform an assay of MS2 bacteriophage. Seeded influent water is pumped at the prescribed flow rate (i.e., 100 mL/min) through the test units until the next sampling time point. An adjacent 30 gallon carboy is filled with seeded MS-2 bacteriophages as previously described. The Pharmed tubing used to draw the influent from the carboy is transferred to the adjacent carboy when only 10 L of influent remain in the original 30 gallon carboy.

Effluent is then collected at each sampling time point (i.e., 1, 6 and 10 hours) at the volumes previously described to assay the MS-2 bacteriophages according to Section IV-B. As a result, a VRI of 99.9999% is obtained at 100 mL/min after 10 hours. The test units are unclamped from the testing stand and disconnected from the Pharmed tubing after the last sampling time point is reached (i.e., 10 hours). The test units are then autoclaved after the analysis is completed.

1-9. (canceled)

10. A method of removing nano-sized pathogens from a liquid, comprising:
(a) providing a filter, wherein the filter comprises:
i) a housing, and
ii) a filter core disposed within the housing having particles comprising activated carbon particles, excluding activated carbon particles treated with metal salts,
iii) wherein the activated carbon particles provide the filter a Pathogen Removal Index (PRI) of at least about 99.99%; and
(b) contacting the filter with a liquid to remove nano-sized pathogens from about 20 nm to less than 500 nm from the liquid.

11. The method of claim 10, wherein the step of informing a user comprises informing a user that the filter may remove bacteria, viruses, or microorganisms from the liquid.

12. (canceled)

13. The method of claim 10, wherein the particles have a bulk density of from about 0.6 to 0.8 g/cm³.

14. The method of claim 10, wherein the filter has a VRI of at least about 99.99% at a flow rate of 100 ml/min. at 1 hour at an influent concentration of 5×10⁸ MS-2 bacteriophages per liter.

15. The method according to claim 10, wherein the step of informing a user comprises informing a user that the filter has a VRI of at least about 99.99% at a flow rate of 100 ml/min. at 1 hour at an influent concentration of 5×10⁸ MS-2 bacteriophages per liter.

16-20. (canceled)
